(19) United States
(12) Patent Application Publication
(10) Pub. No.: US 2003/0093530 A1
(43) Pub. Date: May 15, 2003

(54) Arbitrator system and method for national and local content distribution

(76) Inventor: Majid Syed, Princeton, NJ (US)

Correspondence Address: Blaney Harper, Jones, Day, Reavis & Pogue, 51 Louisiana Ave., NW, Washington, DC, 20001, US

(21) Appl. No.: 10/044,195

(22) Filed: Oct. 26, 2001

(51) Int. Cl. G06F 15/16

(52) U.S. Cl. 709/226; 709/231; 725/119

(57) ABSTRACT

A system and method for intelligently scheduling, through multilevel arbitration, broadcast digital radio content and advertising using a sophisticated communication protocol. Arbitration of broadcast time slots is based on classifications, prioritization, level of service required, bit rate and QoS (quality of service) requirements, best acceptable effort, and type of data (e.g., audio, video, graphics, text) broken into real-time or non-real-time determinations. A hierarchical gateway system is used to arbitrate and schedule the broadcasted content for each broadcast station (exciter). The broadcasted content includes material from national and local content providers to include music, video, graphics, text, and partial content downloads. A central gateway receives requests from national content providers to fill broadcast slots. The requests include the parameters necessary to, not only arbitrate content and advertising, but also to arbitrate based on a recognition of specific content type, requirement for broadcast, and end user device requirements.

### RELATED APPLICATIONS

This application is related to commonly assigned and co-pending applications entitled “System and Method for Providing a Push Gateway Between Consumer Devices and Remote Content Provider Centers” and “System and Method for Push/Pull Gateway Directed Digital Receiver.”

### FIELD OF INVENTION

The present invention relates generally to the field of broadcast communications. More specifically, the present invention is related to prioritization of content scheduling in a digital broadcast system.

### BACKGROUND OF THE INVENTION

Broadcasting of content, such as television shows and advertising, first requires a coordination of scheduling at the national level and then again at the local level. Television networks negotiate and distribute a prescheduled broadcast of shows and advertising down to the local stations. At the local stations, a determination is made as to what local shows (e.g., local news, sports, etc.) or advertising will replace the time slots originally filled at the network level.

The following patents describe prior art methods of broadcast scheduling of content and advertising.

U.S. Pat. No. 5,686,954 to Yoshinobu, et al. entitled, “Program Information Broadcasting Method Program Information Display Method, And Receiving Device” provides for a plurality of classification items each including a plurality of detailed items for recognizing broadcasting programs per se and program elements included in each of the broadcasting programs are provided wherein the contents of each of the broadcasting programs are represented by the classification items and the detailed items that are respectively represented by the identification data are used to form scheduled program information. The scheduled program information is broadcast together with the corresponding table data for the identification data and the data for character display of the classification items and the detailed items corresponding to the identification data. Program schedules for various kinds of broadcasting programs can be broadcast with a reduced amount of data.

U.S. Pat. No. 6,173,271 to Goodman, et al. entitled, “Television Advertising Automated Billing System,” includes advertising marked with a code in a way which makes it difficult to fool the system. The advertising is marked with a code at the time the advertising is produced. Then, when the advertising is broadcast, the code on the advertising is analyzed. Different security measures can be used, including producing the code in closed captioning so that many different people can see the code, or comparing codes in one part of the signal with a code in another part of the signal. Measures are taken to prevent the code from being used to detect commercials. According to another part of this system, a paradigm for a clearinghouse is disclosed in which the user signs up with the clearinghouse, obtains a line of credit, and the advertiser, the agency, and the ad producer also subscribe to the service. When the ad is actually aired, the payment can be automatically transferred.

U.S. Pat. No. 4,720,873 to Goodman, et al. entitled, “Satellite Audio Broadcasting System,” provides for a satellite audio broadcasting system for network programming and broad-based advertising including a network uplink facility and a plurality of local radio station downlink facilities. The system permits pre-empting of network audio by the local station at any time, but automatically and constantly monitors the local broadcast, comparing it to the network audio, and automatically records any periods of departure. Computers are employed at uplink and downlinks, and from time to time the uplink causes each downlink to transfer to it all data relating to such periods of departure for the subject period of time. Using the data, this uplink can automatically compute billing to advertisers and payments to subscriber local stations based on the amount of advertising actually broadcast by the stations. Verification is thereby fully automatic and is substantially tamper-proof. Digital databursts preferably are transmitted via the satellite along with the network audio for separation, decoding and use at the downlink. Such data may contain, for example, a program pre-schedule for the coming day and/or simultaneous identifying information at the time a program or advertising is aired, for downlink logging, and individual accessing codes for network control or communication with specific downlink affiliates.

U.S. Pat. No. 4,025,851 to Haselwood, et al. entitled, “Automatic Monitor for Programs Broadcast,” provides for a system for automatically monitoring the programs broadcast by network affiliated broadcasting stations includes a plurality of remote monitoring sites and a central office for periodically interrogating the remote monitoring sites. Each remote monitoring site contains apparatus for monitoring time varying program identifying data and for storing the data in a change format when the time varying data changes in an unexpected manner. An elapsed time clock in each remote monitoring unit generates a record of the elapsed time between the unexpected changes. Each remote unit includes a minicomputer having a read-only memory and a random-access memory. The data in the read-only memory serves to establish communications with the central office and permits the central office to access the random-access memory. After the random-access memory has been accessed, it may be reprogrammed to alter the operation of the remote monitoring unit to accommodate different data formats or different information.

U.S. Pat. No. 5,182,640 to Takano entitled, “Program Transmission System And Method,” provides for a broadcast program transmission control apparatus and method using a scheduling computer to produce program scheduling signals representing a schedule of programs to be generated at predetermined times by respective ones of a plurality of program generation devices; each program generation device is provided with a corresponding controller into which the respective program scheduling signals are downloaded from the scheduling computer; and a switching device is operative to switch the programs generated by the program generation devices to a master broadcast output.

The prior art systems fail to include, among other things, a multiple level arbitration of multimedia content, advertising, data downloads, retransmissions, pulled Internet data content, or device specific requirements.

Currently, approximately 10,000 radio stations are located throughout the U.S.A., reaching a vast audience. U.S. radio stations are operating with analog technology and are almost evenly divided between two broadcast spectrums: amplitude modulation (AM) at 0.525-1.705 MHz and frequency modulation (FM) at 88-108 MHz. A new emerging technology known as in-band on-channel (IBOC) allows these radio stations to deploy digital transmission technology within existing bandwidths allocated to the AM and FM stations. Digital transmission allows data processing in strings of 0's and 1's, rather than analog transmission by means of electronic signals of varying frequency or amplitude that are added to carrier wave of a given frequency. Digital technology is primarily deployed in new communication media, such as computers and fiber-optic networks. By way of example, a modem is used to modulate outgoing digital signals from a computer to analog signals for a conventional copper twisted pair telephone line, to demodulate the incoming analog signal, and to convert it to a digital signal for the computer in order to facilitate communication via the Internet.

Web Casting technology is the prearranged updating of news, weather, or other selected information on the interface of a device with digital capabilities through periodic and generally unobtrusive transmission. Currently, Web Casting technology primarily targets computer users. Yet, as described above, there is a huge audience in the radio broadcast area, and there exists a strong demand for data casting content such as: song titles, artist names, lyrics, traffic and weather news, stock market quotes, pager messages or complementary product information. New radio receivers with Liquid Crystal Displays (LCD) or PDA like device combined with the deployment of the inbound on-channel (IBOC) technology facilitate such data casting.

### SUMMARY OF THE INVENTION

A system and method for intelligently scheduling, through multilevel arbitration, broadcast digital radio content and advertising using a sophisticated communication protocol. The protocol comprises one or more fields which extend limited prior art programming scheduling decisions based more generally on content descriptive information (e.g., CBS Nightly News, NY City news, LA County news, Washington, D.C. weather, national advertising, or local advertising) and desired broadcast times. Arbitration of broadcast time slots is based on classifications, prioritization, level of service required, bit rate and QoS (quality of service) requirements, best acceptable effort, and type of data (e.g., audio, video, graphics, text) broken into real-time or non-real-time determinations. Thus, the arbitration of the parameters received in the short messages enable a multilevel determination of relative value and enable optimization based on a plethora of possibilities.

A hierarchical gateway system is used to arbitrate and schedule the broadcasted content for each broadcast station (iExciter). The broadcasted content includes material from national and local content providers to include music, video, graphics, text, partial content downloads, etc. A central gateway receives requests from national content providers to fill broadcast slots. The requests include the parameters (as described above) necessary to, not only arbitrate content and advertising, but also to arbitrate based on a recognition of specific content type, requirements for broadcast and end user device requirements. Unlike the prior art, where 30 minute shows and 30 second interval advertising of a single format were arbitrated, the present invention has to arbitrate millisecond data slots, multimedia data content which is separated for broadcast by content and rejoined at client devices at a later time, as well as music, advertising content, as well as other digital data content.

A data gateway for remote content provider centers or content sponsors is used to push data or have it pulled from remote networks, and to broadcast it thorough an existing in-band on-channel (IBOC) network to IBOC enabled consumer devices. The gateway particularly serves as a data concentration and management center with several data processing features for facilitation of data transmission. The employed transmission protocol for data pushes from push initiators to the gateway supports operations such as push authentication and submission, delivery instructions, result notification, and various scheduling features. The employed transmission protocol for data pushes from the gateway to the targeted mobile devices within reach of the IBOC broadcast network supplements the existing network broadcast protocols by enabling continuous broadcast of digitized content without the use of sessions. It supports handling of transmissions errors, various addressing schemes, multiple transmission speeds, prioritization of content, and other scheduling features. Additionally, the push-pull gateway provides for a mechanism for automatically pulling data from pre-defined channels on remote networks (such as the Internet) before the data is pushed to client receivers on networks such as an IBOC network.

### BRIEF DESCRIPTION OF THE DRAWINGS

FIGS. 1a-1d collectively illustrate various configurations of the present invention system for arbitration and scheduling.

FIG. 2 illustrates the parameter fields of the present invention protocol.

FIG. 3 illustrates the parameter fields of FIG. 2 in greater detail.

FIG. 4 illustrates an overview of a gateway system using the present invention.

FIG. 5 illustrates content provider-to- gateway communications.

FIG. 6 illustrates a specific gateway system using the present invention.

FIG. 7 illustrates the bandwidth scheduler of the present invention.

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention. The terms gateway, iPPG, and iGateway are considered interchangeable as used throughout the specification and drawings. The terms application service providers (ASPs), local content providers, and content providers are considered interchangeable as providers of content to the system.

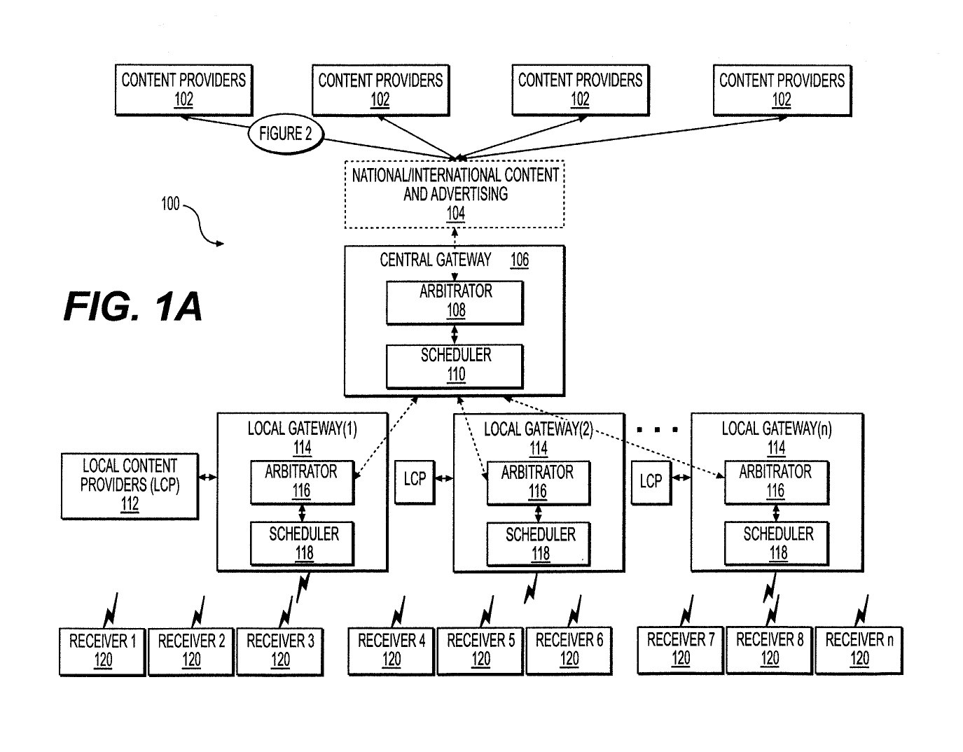

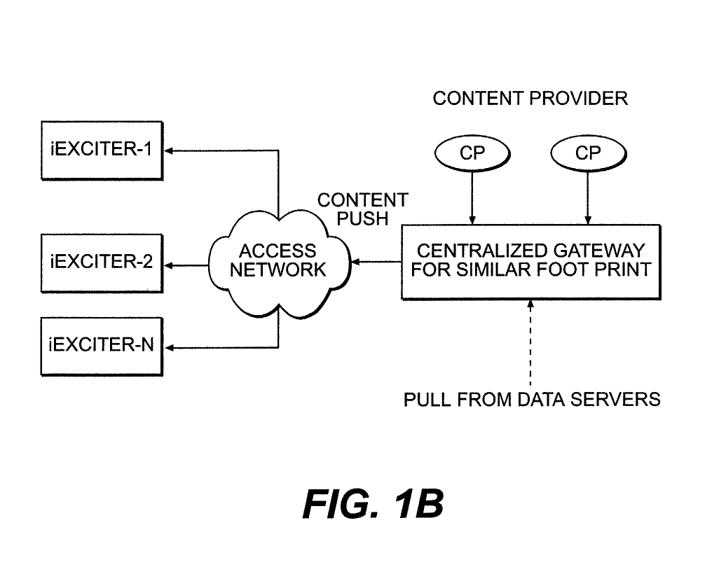

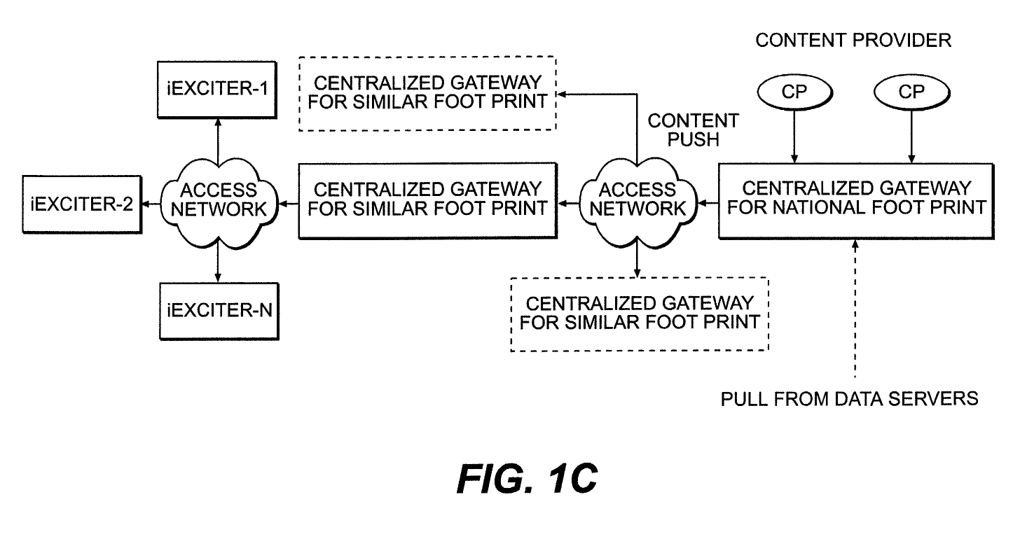

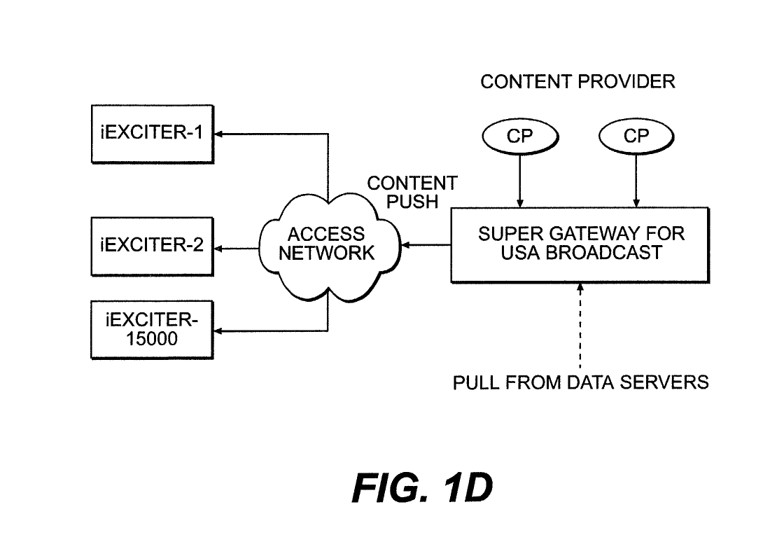

FIG. 1a illustrates a system 100 for arbitrating and scheduling available broadcast time slots as per the present invention. Content providers 102, such as providers of digital radio collections, radio stations, Internet providers, providers of advertising, emergency broadcasting content providers, etc., download requests for access to national broadcast footprint (with bandwidth and time of transmission specified) 104 to central gateway 106. The gateway 106 keeps information about available bandwidth and provides arbitration and scheduling of the requests. Various schemes such as centralized or decentralized pools for arbitration are considered within the scope of the present invention. In a centralized configuration, all local gateways perform minimum functions. Typically only a portion of the total bandwidth is reserved for national/international content. The portion allocated for national/international content is scheduled and passed on to the local gateways 114.

The RF spectrum is a resource, which can be managed by the gateway. For effective utilization of gateway (which by itself is a resource) the following configurations are possible:

Operators, which own multiple stations (which may cover local as well as other geographic foot print), may have one centralized gateway. When content is submitted along with the associated header directly (bypassing 104) or via 104, the centralized gateway has the predetermined intelligence about RF resource availability (i.e. bandwidth) for various radio stations. The centralized gateway 106 therefore, can accept or reject or propose alternatives or may do predownloads. This approach eliminates the need for Local Gateways 114 1, 2, . . . , n. The trade-off being that the central gateway 106 must be very reliable and underlying access network must have redundant links (not shown).

Operators that own single radio stations which cover similar contours with other local stations, may like to have a centralized gateway (FIG. 1b). The operators do not need to repeat common information such as weather, traffic, ads, etc. Instead, a centralized gateway intelligently schedules content. Again, gateway 106 acts as a concentrator for collecting contents for small operators, which can now have a virtual bigger footprint. Again, doing so, local gateways are not required. Instead, one gateway has all the functionality.

For operators that own single radio stations and are geographically apart (or do not have a similar contour footprint), they may like to increase their footprint, by creating a network of gateways (FIG. 1c). This scenario is not applicable to location specific content such as traffic/weather; however, any other information which needs a larger footprint such as news, franchise ads etc. can be well managed by the gateway 106. In this scenario, a local gateway is required to do management of local content. This gateway may be underutilized in its ability, with trade-off being reliability constraints are not that stringent.

For the entire above, one centralized super gateway 106 can effectively perform push content management 102, pulling content management from data sites and management of billing and device profiles (FIG. 1d). However, one super gateway should not perform a call center for uplink receivers.

At the local gateways, local content providers 112 will request access to both content already allocated to the national/international content providers as well as remaining time slots (bandwidth). The requests will be arbitrated 116 with the other requests and previously scheduled national/international content, scheduled 118 and broadcast to the receiving end users devices (clients) 120.

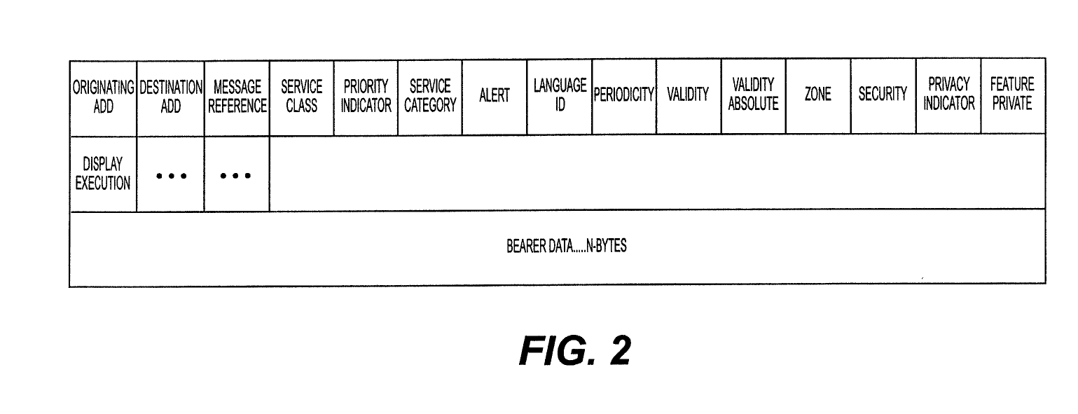

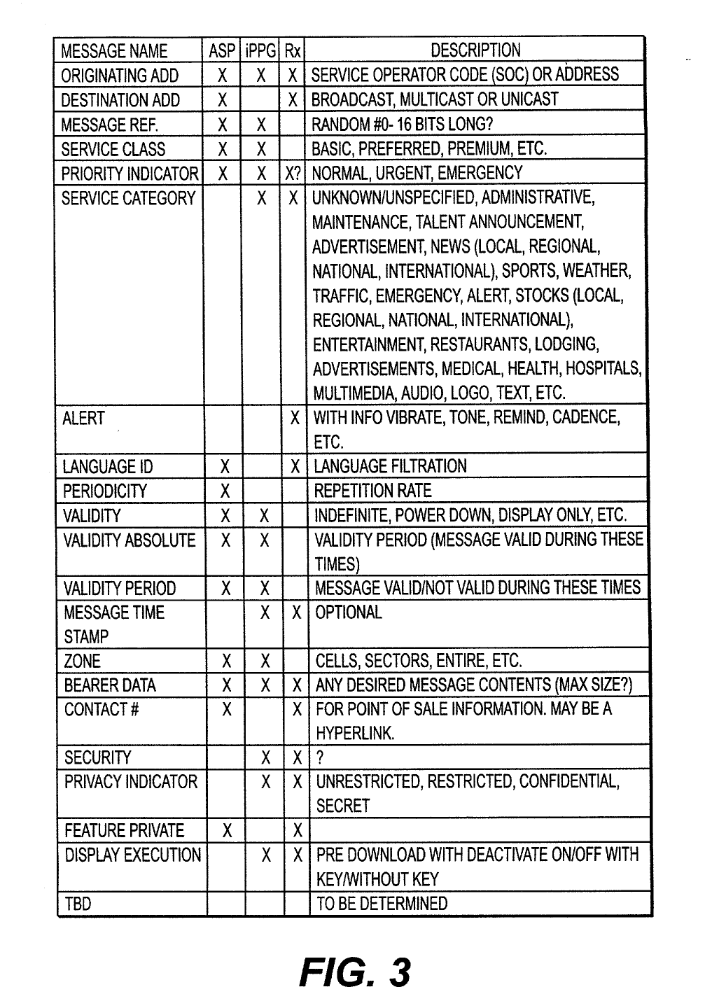

A non-exhaustive list of fields of broadcast parameters is provided in FIG. 2 and in more detail FIG. 3. These fields are presented as options, which content providers, such as advertisers, need to select. In the preferred embodiment, these fields are provided in XML/HTML or by HTTP. During arbitration, considerations of these fields enable a higher level of complexity and optimization than heretofore known.

Arbitration and scheduling of messages depend on a variety of factors, as described above, including the priority of messages, i.e., premium service first, followed by bit rate, latency grades, best effort, etc. Some of the other dimensions of scheduling include:

Time at which a message should commence over the air transmission.

Time at which a message should cease over the air transmission.

Rate at which over the air transmission of the message should be repeated.

Pre-download with deactivate flag turned on, and at scheduled time, deactivate flag turned off.

It should be noted that a broadcast association allocates a service operator code (SOC) to uniquely identify the radio operator. Turbobroadcast layers use this field as an exciter covered zone. It should, however, be noted that the FCC has already defined these zones. Thus, the gateway pulls the deterministic information from the FCC database and uses this information for address verification purposes. The zone field identifies the iExciter/Zone (or contour) to which the message applies. In the preferred embodiment, the zone (or contour) list contains at least one zone (or contour) and the gateway keeps a log of OTA transmissions. The billing management layer or OAM layer uses this information for later use. This parameter is a list indicating the number of times the message has been sent to each iExciter/Zone (or contour) and if iExciter has completed OTA transmission. It should be noted that the number-of-broadcasts-completed can be set to zero if there were no broadcast messages sent.

Additionally, a failure field identifies the list of exciters for which the iPPG/iExciter could not complete the request. Additionally, the failure cause for each zone (or contour) is also indicated.

An optional diagnostic field provides additional information associated with the cause parameter and optionally contains parameters that cannot be interpreted/executed.

The preferred embodiment fields are described in greater detail hereafter:

Priority Indicator: The priority field has the following sub-classification:

Extreme High priority: Suspend Current OTA transmission. This is useful in emergency alert situations.

High Priority: OTA transmission occurs at the earliest opportunity.

Normal: OTA transmission according to the associated repetition rate. If the category is omitted, the default category implied is “Normal” message.

Background/Low: OTA transmissions in the slots left free by messages of category “High Priority” and “Normal”, and can be shared with unscheduled messages. The repetition rate defines the minimum broadcast requirement.

Service Class: This is a grade of service, which content providers request. For example, basic, preferred, premium, etc. The operator may define more service grades. Each service grade has Quality of Service (QoS) assigned over iBOC. In addition, based upon service grade, priority indicator is set. Service grade is terminated at iPPG.

Originating Address: This is the address of Content Provider. This could be a telephone directory number (E.164) or MS-ISDN number or an IP address or URI allocated by some Broadcast Interim Authority. This is terminated at the receiver. The application may use this information for buy information.

Destination Address: This field is used for receiver addressing and implies that received content is for point-to-broadcast, point-to-multipoint, or point-to-specific receiver. Content provider must provide this field. The default is point-to-broadcast.

Message Reference: This is a unique numeric identification of specific content. This is also used for acknowledgement to indicate iPPG has received the content. Any change to previously submitted message must use this number as an identifier.

Alert: A flag may be set by the Content Provider to alert the receiver for any specifics. For example, traffic congestion. The content provider may ask the receiver to use local means to alert the listener. The local means could be audible sound, blinking led or flashing info.

Language ID: This is content identification English, French, etc. It allows the receiver scanning application to monitor the language ID indicator. If a listener has initialized the receiver (via MMI) to tune only to specific language, then the scanning application searches for that ID and tuner. If the language ID is not available it tunes to listener defined default, e.g. Language ID=English.

Periodicity: This field is terminated at iPPG. It is an instruction to the iPPG by the content provider how many times, what time of calendar information should be repeated. This is a contractual agreement and involves bandwidth scheduling. IPPG instructs the content provider if its periodicity request can be met or not and may propose alternate available schedules.

Validity: This field is for receiver who can cache the predownload and can determine if the information is still valid. For example, traffic. The traffic broadcast was cached, and after few hours should get locally purged or the gateway specifies a time-to-live indicator. The receiver may make use of this field to make local decisions if it needs to be presented.

Message Time Stamp: This field is appended by the iPPG. Time stamp can be used for many applications. For example, the receiver when connected to call center provides station information and time stamp data to call center. Time stamp is used to retrieve the logged contents. For example, call center may request the iPPG to provide details of contents, which were pushed because it has to process a consumer, buy request.

Zone: If gateways are networked, iPPG can provide footprint coverage. The content provider may select footprint scope.

Security: As data is broadcasted, the content provider may like to restrict its visibility. The content provider may use the destination address field and provide private key (off-line or in mail or by some other means) to decode the contents.

Private Feature: This is a private header and is to be used by content provider should they need to run their own features. This field is provided to allow RF bandwidth lease.

Privacy Indicator: This field allows the receiver not to display the content until a private pin is entered. A low end of security.

Bearer Data: Application payload.

Other set of data for performing the functions of the IBOC services not limited to:

Authentication

Content Category level

Content Rating

Content Type

Data Service Priority

Encryption Modes

External Service Interface

Synchronization

Transactions

Markup Language

Frame Fragmentation and Reassemble Art Receiver

Content Security by Using SDMI

TBD

Service Header Data: Service header data provides information to the receiver about the data services that exist on a channel. The fields may include but not be limited to: Channel ID, Header Size, Data Service Size, Service Count, Service Mask, Service Location.

Data Service Header: This information describes the size of the data services, as well as the modes and methods of encryption and authentication. The list of fields may include but will not be limited to: Data Service Size, Data Service Priority, Encryption Mode, Encryption Method, Encryption Bit Size, Encryption Public Key, Authentication Mode, Time Stamp, Authentication Public Key, Digital Signature Length, Digital Signature.

Data Service Data File: the data service data file is a generic data structure that characterizes a data service and carries data service content. The list of fields may include but will not be limited to: Synchronization Cue, Sender Time Stamp, Receiver time Stamp, Domain ID, Content Rating, Content Category Level, File Size Number, File Size Magnitude, Status Flags, Event ID, Event Indicator, Group ID, Content Type, User Data, Reserved Fields, User Defined Fields.

Synchronization Data: Synchronization data is data transmitted in relation to the audio data. The data consists of a fixed number of fixed size fields that can be used by a device to time different events. The list of fields may include but not be limited to: Synchronization Cue, Synchronization Type, Length, Spacing, Event Timer Count, and Event Timer. This area of the specification also defines the transmission performance requirement of the synchronization data.

Service Mask: A service mask is information associated with a data service that characterizes the nature of the service and its functional requirements. This area of the specification defines the structure and meaning of information in the service mask.

The ASP, upon receiving a FAILURE indication from the iPPG (or iExciter, if duplexed), marks this zone (or contour) as failed and does not send any new submit/modify requests. When the iExciter has performed successful recovery action, iExciter informs iPPG by sending a RESTART indication. This message implies that the iExciter has resumed OTA operation. It should be noted that the iPPG is also able to trigger a RESTART to the iExciter (this is desired when upgrading software). In case of an iExciter failure such as iExciter down, over load, or hard/soft restart, the initiator (iPPG) is indicated about the loss of information. This may be communicated to Push initiator. If Push initiator does not receive confirmation, it retries submitting the information for some predetermined threshold amount of time. No response from iPPG could mean iPPG is down.

It should be noted that the iPPG attempts to deliver the contents until a predefined timeout expires. The push initiator and/or policy of the broadcast operator set(s) this timeout. Thus, the net result of this function is an asynchronous operation from the advertisers point of view (i.e., the initiator need not wait on-line for the iPPG to complete its delivery). Next, a description of local iGateway functions is given below.

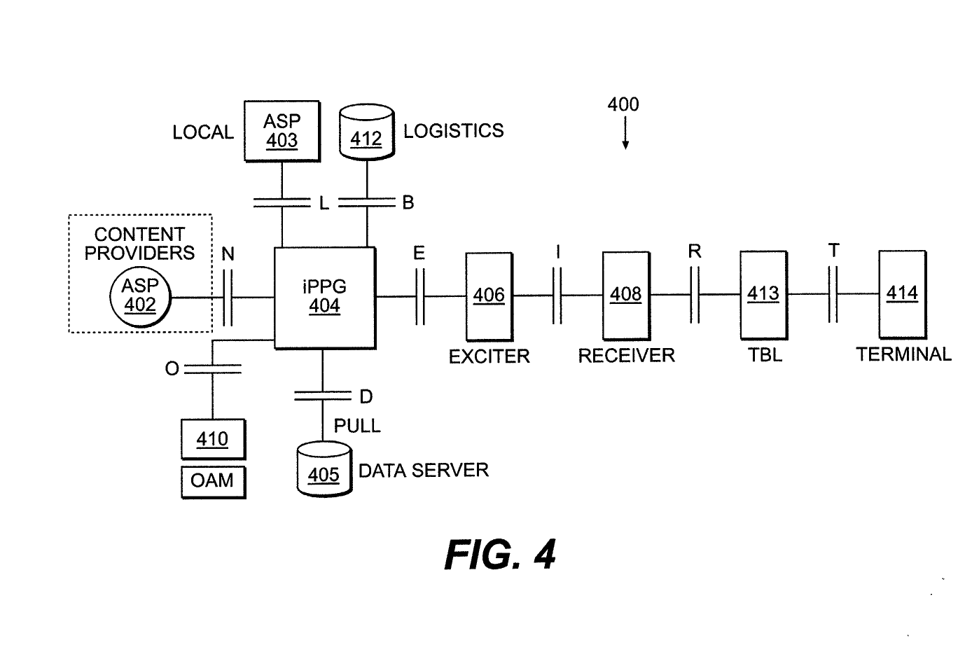

FIG. 4 illustrates a Push-Pull Gateway (hereafter iPPG or iGateway) End-to-End (E2E) system 400 used to implement the present invention. This Push-Pull Gateway system is described in greater detail in co-pending application entitled “System and Method Providing a Push Gateway Between Mobile Devices and Remote Content Provider Centers.” The system components (to be described below) of the iPPG collectively achieve the Push, Pull, and send features of the gateway (iPPG). In FIG. 4, the remote 402 or local 403 application service providers (ASPs) submit (or Push) contents, over a network N (e.g., the Internet) via a protocol such as HTTP, to the iGateway 404. The iGateway 404 is able to either accept or reject such requests by ASPs 400. The iGateway is also able to retrieve (or Pull) contents from Data Server 405 as selected by the operator. The iPPG of the present invention, with the help of an operation administration module (OAM) 410, prioritizes, schedules, and sends datagrams to the radio transmitter station or iExciter 406. Receiver 408 (client) acquires the data and a turbobroadcast layer 413 de-encapsulates the data. The data is then displayed on terminal 414. Furthermore, a billing procedure keeps track of all data pushes (via pre-defined logistics 412) from various ASPs for billing purposes. As will be detailed later, when in listen mode, the data receiver 408 displays the received data continuously, or, upon demand, as per filtration activated by subscriber (e.g., listener).

It should be noted that the ASP 402 is able to communicate with iPPG 404 via various access mediums known in the prior art. However, in the preferred embodiment, the access medium is a plain old telephone system (POTS). Furthermore, the ASP 402 is also able to establish a session using transmission control protocol (TCP) over an Internet service provider (ISP) network. It should, however, be noted that although establishing connections between ASP and iPPG via TCP is described, one skilled in the art can envision using other protocols including, but not limited to, the point-to-point protocol (PPP).

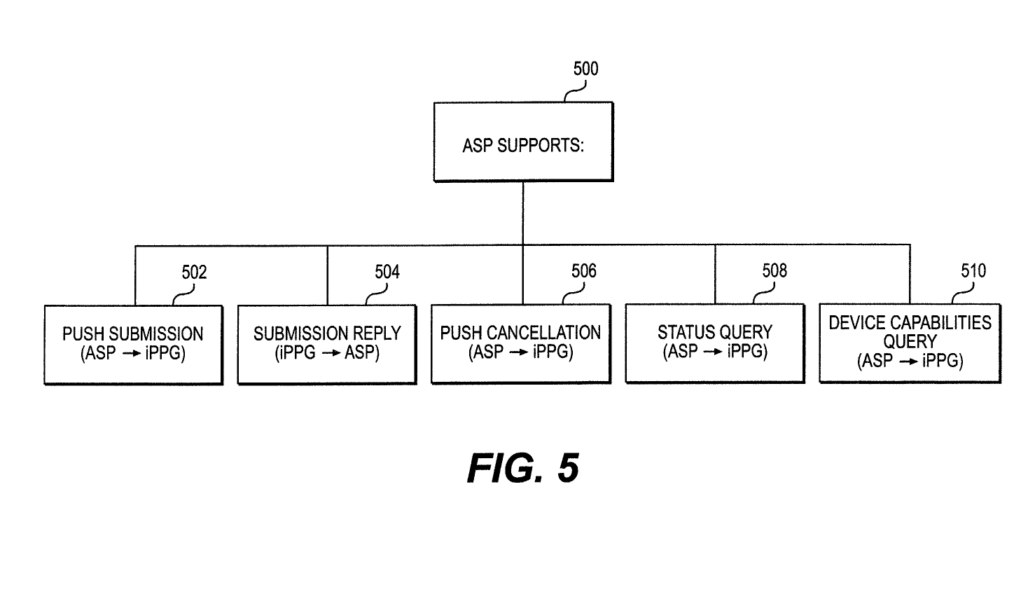

The remote ASPs 402 submit (Push) contents using a protocol such as HTTP. In the preferred embodiment, and as shown in FIG. 5, the ASP supports 500 the following functions:

Push Submission (ASP to iPPG) 502: When information is to be sent from ASP to the iPPG, the transmission is accomplished via a Push submission from the ASP to the iPPG. The Push message contains three entities: a control entity, a content entity, and optionally a capability entity. The control entity is a header that contains delivery and other instructions destined for the iPPG. The control entity may terminate at iPPG or at the InBand On-Channel (hereafter iBOC or IBOC) device. Furthermore, in the preferred embodiment, the ASP is able to set a confirmation flag for message submission and message over-the-air (OTA) transmission.

Submission Reply (iPPG to ASP) 504: A confirmation message is generated if the Push initiator has requested confirmation of successful delivery. The message is generated from the iPPG to the ASP when the content has been received by the iPPG. Optionally, the iPPG is also able to notify the ASP that the message has been scheduled for OTA transmission. Furthermore, if the ASP does not receive confirmation, it retries by submitting the information for a predetermined threshold amount of time. It should be noted that no response from the iPPG could mean that the iPPG is down. In the preferred embodiment, it is the responsibility of the ASP to determine when iPPG services become available again. Therefore, the ASP keeps performing random retries.

Push Cancellation (ASP to iPPG) 506: A Push cancellation is possible in the instance that iPPG has accepted the contents, but has not yet scheduled an OTA transmission. In this case, the ASP is able to request a cancellation of previously submitted content. The iPPG responds with whether or not the cancellation was successful. It should, however, be noted that although deletion of submitted (Pushed) content in end devices is not mentioned in detail herein, one skilled in the art can envision extending the present invention to encompass such options without departing from the scope of the present invention. If pre-download has occurred with deactivate flag enabled, then a push cancellation message instructs iPPG not to activate the flag.

Status Query (ASP to iPPG) 508: In this scenario, the ASP is able to request status of previously submitted content and the iPPG responds with current status of submitted content.

Device Capabilities Query (ASP to iPPG) 510: To create better-formatted content for a particular iBOC device, the ASP requests the capabilities of a particular device on the iBOC network. The iPPG maintains a device profile database of registered OEMs and, in the preferred embodiment, shares this information with the ASP. It should be noted that, although in the preferred embodiment a device profile database is mentioned in conjunction with the iPPG, one skilled in the art can envision the ASP using other means (such as the Internet) to extract such profile information.

As mentioned earlier, the Push download at the iPPG is carried out via protocols such as HTTP. It should, however, be noted that the data receiver does not perform any protocol mapping as the ASP uses standard API, which the end device is equipped with, or optionally, the end device equipment is preloaded with non-standard API by using an original equipment manufacturer (OEM) provided serial interface and drivers. Furthermore, the ASP provides a selection of various fields (services and control categories) as provided by the iPPG. Additionally, if a mandatory element is not initialized, the iPPG performs default initialization.

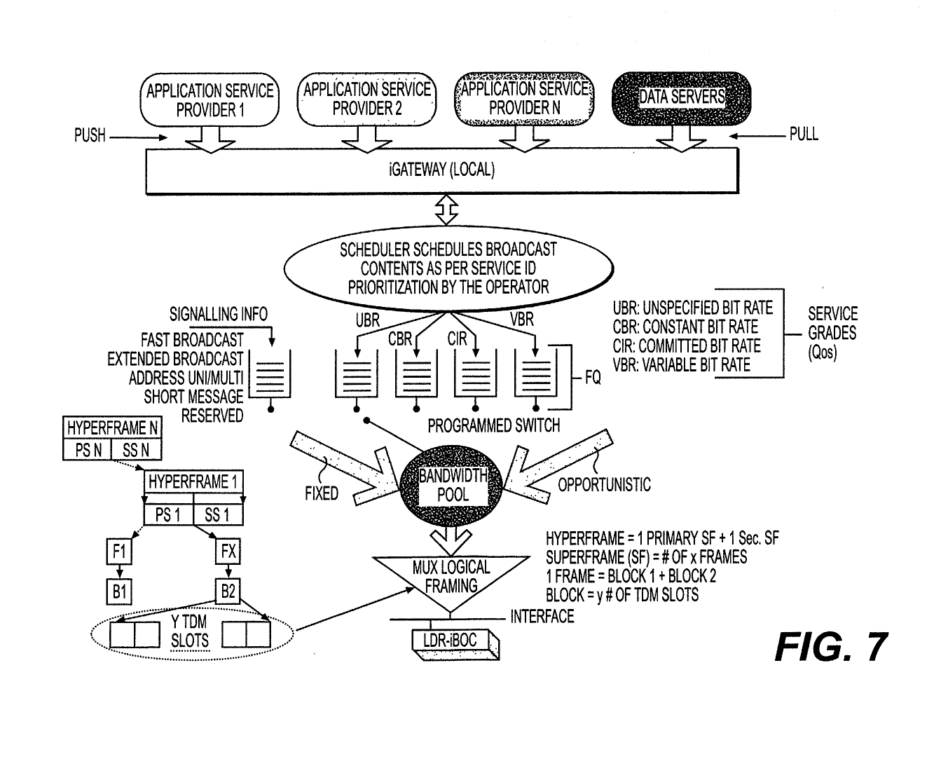

Now, a description of the scheduling of content that can be separated during broadcast is given (FIG. 7). In broadcasting, prime time is the most appealing time slot for broadcasters and advertisers. But, due to the limited bandwidth, every over the air request at prime time cannot be handled. In a non real-time scheduling scenario, the iGateway of the present invention handles this transmission of contents as follows. The iGateway transmits the content in advance with receiver Display Deactivate Flag enabled (data content not activated). Thus, at prime time, the Display Deactivate Flag is disabled (content available to client). If a receiver was left off during this pre-download, the scheduler can schedule a repeat at prime time (if possible). However, this is not guaranteed.

On the other hand, in a real-time scheduling scenario, the iGateway is always aware of the over the air bandwidth availability for a defined calendar. When iGateway is accessed, the ASP is informed regarding the availability of slots and their associated cost. Furthermore, upon some dialogue interaction, the iGateway is able to accept or reject the contents to be transmitted over the air.

In yet another embodiment, the iGateway allows other programs, such as bulletin boards, to kick off auto download. For example, using a protocol such as file transfer protocol (FTP), the iGateway polls information sites such as weather, traffic, stocks, or games at pre-defined time periods, and broadcasts any extracted information to the end devices.

In yet another embodiment, schedule messages are generated indicating the intended schedule of transmissions. It should be noted that such schedule messages are helpful in minimizing battery in the iBOC enabled receiver, because it allows the receiver to ignore transmissions of messages the subscriber (or listener) is not interested in. In an additional embodiment, a specific channel for broadcasting the content is selected for over the air transmission.

Additionally, the iPPG is able to copy selective, random, or all pushed and pulled content in a separate buffer called the passive queue. Thus, when all contents are served from the active queue, the scheduler transmits from the passive queue. Furthermore, the over the air transmission packets are tagged identifying that these contents are from the passive queue. In the preferred embodiment, the receiver maintains the passive queue. Thus, the receiver, when composing messages, ensures completeness by retrieving packets from the passive queue.

The present invention also includes a pseudo algorithm for bandwidth management called fair queuing. The application kernel looks at the appropriate header bits to determine advertisers' requested grade of service. It then routes the information to one of the fair queues (FQ). Fair queuing is used to prioritize flows per QoS (or grade of service) traffic attribute and, at the same time, keeps resource starvation at its minimum. It should be noted that if an FQ flow does not use its assigned bandwidth, other flows are able to use it. Furthermore, each FQ has sub-queues and packets are scheduled so that each flow receives a constant fraction of the IBOC link bandwidth (especially during congestion/collision schedule).

Each iPPG of the present invention is able to serve multiple ports simultaneously. In this embodiment, the extra traffic is routed or negotiated with third party servers. Furthermore, in another embodiment, fixed/deterministic contents such as images, logos, etc., are downloaded during pre-download times. Then, the ASP transmits updated messages as per demand, which are later composed with the pre-downloaded content.

In an extended embodiment, bulk download such as e-newspaper, e-books, software upgrades, etc., are performed during non-traffic hours such as midnight. The download confirmation is acknowledged via device uplink. Should a particular receiver fail to compose the download, the receiver sends an uplink request regarding missing records. Additionally, in this embodiment, the iPPG gathers statistics to decide if there is a need to repeat rebroadcast or rebroadcast some segments of the transmission or to individually send the missing records to each receiver, using device uplink.

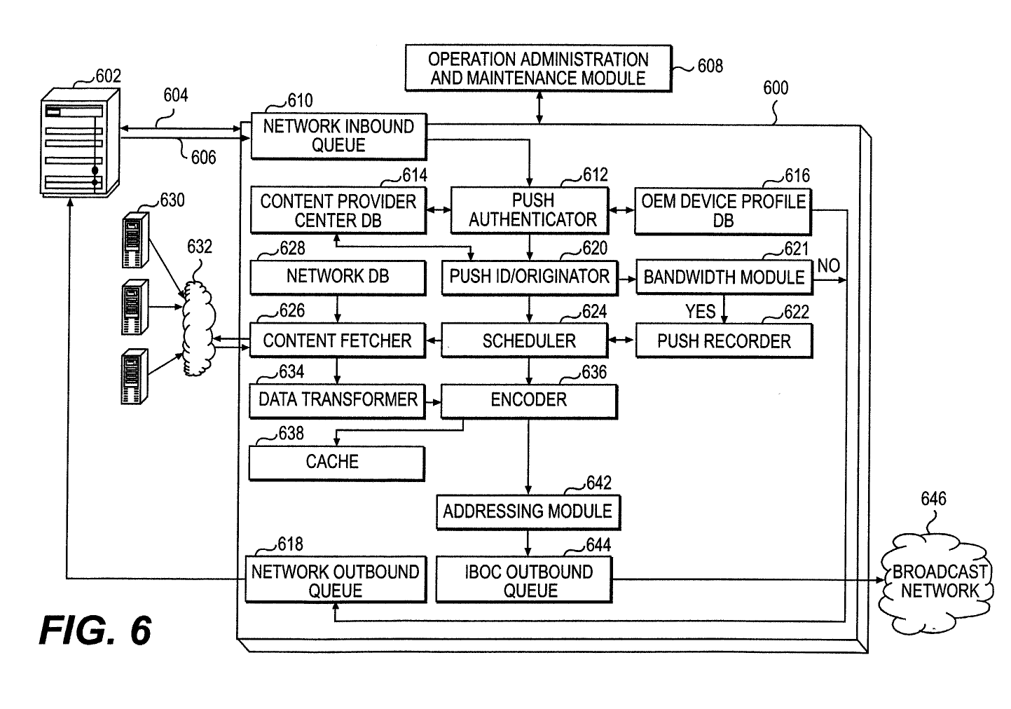

FIG. 6 illustrates, in greater detail, the functionality of iPPG 600. The content provider center 602 establishes session 604 with iPPG 600. The established session provides for a data link such as a link based upon a standard peer-2-peer protocol or any other data communication link. Furthermore, as shown in FIG. 6, an operation administration and maintenance module (OAM) 608 controls, in an event driven manner, the iPPG 600 of the present invention. Content provider center 602 is able to submit a push request 606 to the iPPG 600, where it is first received by the network inbound queue 610. Next, push authenticator 612 identifies and authenticates content provider center 602 as the push initiator. This authentication is performed based upon information stored in content provider center database 614. Furthermore, the push authenticator 612 checks if the push message contains any OEM device uplink, GPS, etc., capability queries (a query requesting device requested class (e.g., Text, HTML, WML, etc.), and if so, the queries are passed onto subscription profile database 616, wherein the device profiles of queried devices are extracted and passed on to the network outbound queue 618 for transmission to the content provider center 602. This allows content providers to test its presentation and how it will look when iBOC receiver presents it to the OEM device. On the other hand, if the push message is made up of just data content to be pushed (or a request for data content to be pushed), push ID/originator ID numbers 620 are extracted from the content provider center database 614 and passed to bandwidth module 621 to determine if requested bandwidth and time are free. If not, a message is sent to outbound queue 618 with other possible alternatives. If requests can be satisfied, it is passed to the push recorder 622 for storage.

A scheduler 624, then parses control entity of the message and determines time/schedule for contained instructions and passes such information for storage on to push recorder 622. If the instruction extracted by the scheduler 624 includes retrieving data, the content fetcher 626, in conjunction with the scheduler 624 and a network database 628, pulls data from content providers 630 via a network 632, such as the Internet. The pulled data is then transformed and encoded (via data transformer 634 and encoder 636, respectively) into a format requested by the client. Furthermore, data transformer 634 and encoder 636 split the data into octet data blocks, assign serial numbers to all packets, and pass them on to addressing module 642 and cache 638. Additionally, a bandwidth module 640 is used for bandwidth management purposes (described later). Lastly, the data from the addressing module is passed onto the IBOC outbound queue 644 to various end devices linked to a broadcast network 646 such as an IBOC network.

Turbobroadcast is composed of service specific adaptation layer (SSAL) and a proprietary (e.g., iBiquity™) Medium Adaptation control (AM/FM) layer (IMAC (AM/FM)).

It should be noted that the turbobroadcast is accommodated in the iPPG and iBOC receiver. The SSAL performs the quality of service (QoS) functions required by the service specific applications such as delay, loss sensitivity, jitter, or differential broadcast services as defined by the operator, etc. Additionally, SSAL operates in two modes of SSAL services: message mode and a streaming mode.

In the message mode, the service specific adaptation layer-service data unit (SSAL-SDU) is passed across the iBiquity medium adaptation control (hereafter iMAC) in exactly one service specific adaptation layer-interface data unit (SSAL-IDU). This service provides the transport of a single SSAL-SDU in one segment. Generally, this mode is used for operation administration and maintenance (OAM) signaling carried in the Common Part Indicator—CPI of iMAC.

In the streaming mode, the SSAL-SDU is passed across the fragmentation interface in one or more SSAL-IDUs. The transfer of this SSAL-IDUs across the iMAC interface occurs separated in time (this is to accommodate QoS related issues and is handled by the bandwidth (BW) scheduler). An internal pipelining function in the (receiver) SSAL is applied which provides the means by which the sending SSAL entity initiates the transfer to the receiving SSAL entity before it has completed SSAL-SDU available.

The iPPG SSAL performs functions required by the service specific applications such as delay, loss sensitivity, jitter, or differential broadcast services such as audio, video, data, multimedia message service as defined by the content provider(s). These parameters are reflected in the iMAC header and intelligently used by the exciter physical layer, by placing sensitive content into non-sensitive regions of the broadcast spectrum.

As previously mentioned, the iPPG SSAL features a message mode and a streaming mode. The receiver's iMAC performs functions such as look-around and sequenced assembly of data packets. In the receiver assisted look around, the receiver determines if the channel quality is bad (via channel quality measure) and makes a decision on which channel to pick for retrieving data, if any. In the event there exists a good channel for transmission, the iPPG sends a message (in its control channel) to only look for some specific broadcast frequencies. This allows for increased virtual bandwidth. TBL-Receiver performs reassembly of stream mode, parses it, determines segment order, detects transmission errors, and further performs message compose. This is then given to the receiver OEM.

Given below is a detailed description of the iGateway (or iPPG) and its components. The iPPG of the present invention can be initialized for the following parameters:

Exciter initialization for continuous Push by iPPG or upon demand by exciter.

Audio Bandwidth Calendar. By default, the left over bandwidth is used for supplementary services such as data.

Pull schedule.

Pull reference address and individual mechanism.

Real-time or non-real-time Push. In the preferred embodiment, the real-time push uses ASP simplex communication with the client (via an intermediary iPPG). Non-real-time is a pre-download where the deactivate flag is on with the condition that the receiver is always on.

Initializing customer database. iGateway is able to then decide the policies about who is able to gain access to the iBOC network, who is able to Push content and who is not, and under which circumstances and parameters, etc.

Priority setting (via OAM element management).

Queue prioritization and charge rate association.

a. Other data related attributes such as number of QoS support, timers, etc.

b. Customer database update.

Billing cost definition.

Moreover, the iPPG also maintains a log of broadcast detail records (e.g., for the purposes of billing). In one embodiment, to improve OTA efficiency, a numeric identifier is used instead of an URI. In this case, a broadcast interim authority assigns numbers to well-known user agents to avoid the overhead of sending an URI. The broadcast interim authority publishes a list of assigned numerical identifiers. If an iPPG requests to Push content with an application address URI that the iPPG recognizes as an URI that has broadcast interim authority assigned numeric identifier, the URI is replaced with the numeric identifier. In an extended embodiment, the Push initiator requests a numeric identifier to be used (an identifier that is not registered). The iPPG is also involved in reliability, i.e. rate at which broadcast of message should be repeated, time at which a message should commence broadcasting, determining pre-download with deactivate flag enabled, and determining when to activate the deactivate flag.

Furthermore, the iPPG initiates transmission by sending fixed length short messages to an iExciter, and when necessary, pads the message with appropriate character to a length of fixed message octets. It further maintains flow control when received load indication messages indicate an underflow or overflow situation by the iExciter. Additionally, in one embodiment, the iPPG is able to route the contents to selective iPPG (when more than one iPPG exists and are networked). In this embodiment, a centralized gateway for spectrum covering similar footprint performs intelligent scheduling such that the same information is not repeated by each transmitter, keeps track of available bandwidth, and instructs receivers to look around for other information. Additionally, iPPG (if networked) determines the neighboring station (look around) on which the message should be broadcast. The iPPG further routes broadcast messages to the appropriate iPPG (in the instance that more than one iPPG exists and these iPPGs are networked).

The iPPG also determines the time at which a message should cease being broadcast and subsequently instructs each iExciter to cease broadcast of the message. It also determines the set of zones/iExciters to which a message should be broadcast, and indicates within a token number the geographical scope (footprint) of each message (if networked).

The iPPG provides the Push initiator with client device capability lookup services, letting a Push initiator select the optimal flavor of a particular content for a particular client. A Push initiator is able to query the iPPG for client capabilities and preferences, to create better-formatted content for a particular IBOC device. This feature is dependent upon broadcasters who have to maintain registered OEM device profiles. Additionally, broadcasters need to keep track of various receiver classes and if they are registered in its domain for its advanced services.

It should be noted that the iPPG of the present invention is able to communicate with any well-known access networks via protocols such as PPP, TCP/IP, Frame Relay, Enhanced General Packet Radio Service (EGPRS), Sirius®, WAP, MediaPlex®, WML, XML, BlueKite®, or other known or future protocols.

Furthermore, in an extended embodiment wherein the iPPG's are networked, the iPPG routes the messages to the appropriate iPPG. Additionally, the iPPG determines the geographical scope of each message and communicates with the respective iPPG. The iPPG further determines the time at which a message should cease being transmitted over the air and subsequently instructs the connected exciter to cease over the air transmission.

It should further be noted that local transmitters are able to merge their available data bandwidth so that each broadcaster does not need to transmit the same information. Instead, unused bandwidth is used for other data contents. Additionally, if broadcast schedule data is broadcast at a pre-determined time, then regions that are noise affected with one contour pick up the content from another transmission. This scheme helps assure that the receiver receives information that is healthy (because it can compare to the same information transmitted by another transmission). The use of this scheme requires synchronized scheduling.

The control entity is marked up in a mark up language such as Extensible Markup Language (XML) and contains delivery instructions, such as originating and destination address, message ID, priority indicator, message category, repetition rate, message time stamp, privacy indicator, status request, client capabilities query, or cancellation request for previously submitted content. It is understood that the preceding list of possible delivery instructions is non-exhaustive and should not be used to limit the scope of the present invention.

Furthermore, as mentioned earlier (in the bandwidth module description), if the content provider center or content providers themselves desire to fix the bandwidth, then the iPPG is capable of supporting a fixed bandwidth with a defined QoS. During this reservation period, the iPPG simply acts as a transparent conduit. It is the responsibility of the content provider center to make use of the close protocol at the remote receiving wireless device.

The client capabilities are preloaded into the iPPG by the Original Equipment Manufacturing (OEM). Content provider centers are able to query in a markup language format (such as XML) and request the capabilities of a particular device in the IBOC network.

Thus, in summary, the iGateway or iPPG is able to push data from various content provider centers and is also able to pull data from remote content providers. The content provider centers and remote content providers are able to communicate with the iPPG of the present invention via a network (LAN, WAN, Internet, etc.). Based upon the request from the content provider centers, the data is then pushed via a network such as an IBOC network onto various end devices (clients).

The above described functional elements are implemented in various computing environments. For example, the present invention may be implemented on a conventional multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of network communications, mark-up language, and protocol programming.

While the embodiments above have been described with respect to specific implementations, one skilled in the art would envision creating variations of the invention including, but not limited to, one iPPG and many transmitters, a set of networked iPPGs, and a master iPPG and a scaled down iPPG. Furthermore, although the iPPG, remote content providers, and content provider center are shown to be separate entities communicating over various networks, one skilled in the art can envision them as being implemented locally in one single entity. Accordingly, the embodiments described above do not limit the scope of the invention which is set forth in the claims below.

I claim:

1. An intelligent digital broadcast scheduling system, said scheduling system arbitrating the use of specified broadcast time slots, said broadcast comprising one or more or a combination of data content comprising audio, video, text, graphics, images, or data; said data content available across networks, said scheduling system comprising:
a messaging protocol, said protocol comprising at least: priority indicators, service categories, and service classes;
an arbitrator, said arbitrator intelligently determining a relative value of specified priority indicators, service categories, and service classes of data content entities from a group of requesting content providers;
a scheduler, said scheduler collecting and sequencing said data content for broadcast based on said arbitrator determinations; and
an IBOC network broadcasting said data content as per said sequence.

2. An intelligent digital broadcast scheduling system, as per claim 1, wherein said system comprises a hierarchy of gateways, one or more first level gateways arbitrating and scheduling a first data content level and one or more second level gateways operatively connected to said first level gateway(s) and arbitrating and scheduling a second data content level.

3. An intelligent digital broadcast scheduling system, as per claim 1, wherein said one or more first level gateways arbitrating and scheduling a first data content level comprise at least a central gateway receiving requests from a plurality of national/international content providers.

4. An intelligent digital broadcast scheduling system, as per claim 1, wherein said one or more second level gateways receive requests from a plurality of local content providers.

5. An intelligent digital broadcast scheduling system, as per claim 1, wherein said data content is arbitrated based on a plurality of the following parameters: data content, transmission requirements, data type, time, end user device requirements.

6. An intelligent digital broadcast scheduling system, as per claim 1, wherein said data content is prioritized, based on said priority indicators, as one of the following: extreme high priority for immediate data transmission, high priority for transmission at earliest opportunity, normal according to requested repetition rate, and background/low for transmission in slots left free after transmission of messages of extreme high priority, high priority, and normal priority.

7. An intelligent digital broadcast scheduling system, as per claim 1, wherein said priority indicators comprise one or more of the following fields: level of service, bit rate requirements, latency grades, or best effort required.

8. An intelligent digital broadcast scheduling system, as per claim 1, wherein said protocol includes message fields comprising a service operator code identifying said data content provider.

9. An intelligent digital broadcast scheduling system, as per claim 1, wherein said protocol includes message fields comprising a destination address representing a broadcast, multicast, or unicast scenario.

10. An intelligent digital broadcast scheduling system, as per claim 1, wherein said service classes comprise at least basic, preferred, or premium.

11. An intelligent digital broadcast scheduling system, as per claim 1, wherein said service categories comprise at least one, or a combination of: administrative, maintenance, advertisement, news (local, regional, national, international, sports, weather, traffic, emergency alert, stocks (local, national, regional, international), entertainment, travel entities, medical, multimedia, audio, logo, or text.

12. An intelligent digital broadcast scheduling system, as per claim 1, wherein said message protocol further includes language filtration identifiers.

13. An intelligent digital broadcast scheduling system, as per claim 1, wherein said message protocol further includes periodicity requirements.

14. An intelligent digital broadcast scheduling system, as per claim 1, wherein said message protocol further includes validity determinations including periods of validity.

15. An intelligent digital broadcast scheduling system, as per claim 1, wherein said message protocol further includes time stamps of said specified data content.

16. An intelligent digital broadcast scheduling system, as per claim 1, wherein said message protocol further includes periodicity requirements.

17. An intelligent digital broadcast scheduling system, as per claim 1, wherein said message protocol further includes geographic classifications.

18. An intelligent digital broadcast scheduling system, as per claim 1, wherein said message protocol further includes client display execution limitations.

19. An intelligent digital broadcast scheduling system, said scheduling system arbitrating the use of specified broadcast time slots, said broadcast comprising one or more or a combination of data content comprising audio, video, text, graphics, images, or data; said data content available across networks, said scheduling system comprising:
one or more gateways arbitrating and scheduling first and second data content levels, said first and second data content levels received from a plurality of operatively connected data content providers;
a messaging protocol, said messaging protocol used to identify parameters of said requests and comprising at least: priority indicators, service categories and service classes;
an arbitrator, said arbitrator intelligently determining a relative value of specified priority indicators, service categories and service classes of data content entities from a group of requesting content providers;
a scheduler, said scheduler collecting and sequencing said data content for broadcast based on said arbitrator determinations, and
an IBOC network broadcasting said data content as per said sequence.

20. An intelligent digital broadcast scheduling system, as per claim 19, wherein said system comprises a hierarchy of gateways, one or more first level gateways arbitrating and scheduling a first data content level and one or more second level gateways operatively connected to said first level gateway(s) and arbitrating and scheduling a second data content level.

21. An intelligent digital broadcast scheduling system, as per claim 19, wherein said one or more first level gateways arbitrating and scheduling a first data content level comprise at least a central gateway receiving requests from a plurality of national/international content providers.

22. An intelligent digital broadcast scheduling system, as per claim 19, wherein said one or more second level gateways receive requests from a plurality of local content providers.

23. An intelligent digital broadcast scheduling system, as per claim 19, wherein said data content is arbitrated based on a plurality of the following parameters: data content, transmission requirements, data type, time, end user device requirements.

24. An intelligent digital broadcast scheduling system, as per claim 19, wherein said data content is prioritized, based on said priority indicators, as one of the following: extreme high priority for immediate data transmission, high priority for transmission at earliest opportunity, normal according to requested repetition rate, and background/low for transmission in slots left free after transmission of messages of extreme high priority, high priority, and normal priority.

25. An intelligent digital broadcast scheduling system, as per claim 19, wherein said priority indicators comprise one or more of the following fields: level of service, bit rate requirements, latency grades, best effort required.

26. An intelligent digital broadcast scheduling system, as per claim 19, wherein said protocol includes message fields comprising a service operator code identifying said data content provider.

27. An intelligent digital broadcast scheduling system, as per claim 19, wherein said protocol includes message fields comprising a receiver destination address representing a broadcast, multicast or unicast scenario.

28. An intelligent digital broadcast scheduling system, as per claim 19, wherein said service classes comprise at least basic, preferred, or premium.

29. An intelligent digital broadcast scheduling system, as per claim 19, wherein said service categories comprise at least one, or a combination of: administrative, maintenance, advertisement, news (local, regional, national, international, sports, weather, traffic, emergency alert, stocks (local, national, regional, international), entertainment, travel entities, medical, multimedia, audio, logo, or text.

30. An intelligent digital broadcast scheduling system, as per claim 19, wherein said message protocol further includes language filtration identifiers.

31. An intelligent digital broadcast scheduling system, as per claim 19, wherein said message protocol further includes periodicity requirements.

32. An intelligent digital broadcast scheduling system, as per claim 19, wherein said message protocol further includes validity determinations including periods of validity.

33. An intelligent digital broadcast scheduling system, as per claim 19, wherein said message protocol further includes time stamps of said specified data content.

34. An intelligent digital broadcast scheduling system, as per claim 19, wherein said message protocol further includes periodicity requirements.

35. An intelligent digital broadcast scheduling system, as per claim 19, wherein said message protocol further includes geographic classifications.

36. An intelligent digital broadcast scheduling system, as per claim 19, wherein said message protocol further includes client display execution limitations.
